(19) United States
(12) Patent Application Publication
(10) Pub. No.: US 2007/0162871 A1
(43) Pub. Date: Jul. 12, 2007

(54) INFORMATION PROCESSING APPARATUS, CONTROL METHOD THEREFOR AND CONTROL PROGRAM

(75) Inventor: Kenji Ishii, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/382,834

(22) Filed: May 11, 2006

(30) Foreign Application Priority Data
Jan. 12, 2006 (JP) 2006-005407

(51) Int. Cl. G06F 3/048

(52) U.S. Cl. 715/814; 715/823

(57) ABSTRACT

The present invention provides an information processing apparatus, including: a display unit; and a screen control unit for setting a plurality of different focus modes which selectively focus each of first objects displayed in a main display zone of the display unit and of second objects output to a status display zone of the display unit.

### BACKGROUND OF THE INVENTION

1. Field of the Invention

The present invention relates an information processing apparatus, control method therefor and control program, and a technique effectively applicable to a display control of a standby screen, et cetera, for an information processing apparatus such as a portable phone, portable information terminal, et cetera.

2. Description of the Related Art

The uppermost part of a screen of a portable phone for example is equipped with a zone called a status pane for displaying a radio wave condition, a battery status, a mail status, et cetera, by using objects such as pictograph, icon (pictogram), et cetera. The present specification uses icon as a representation of objects such as pictograph, icon, et cetera.

Some portable phones display an icon in a standby screen in addition to a status pane if there has been an incoming mail, a missed call, et cetera, for allowing a list display of incoming mails or missed calls by focusing on the icon, et cetera, and selecting it.

Commercially available office processing application products comprising a GUI (graphical user interface) are furnished with a tool bar function comprising a group of icons, allowing a pointing cursor (e.g., a mouse pointer) operated by a mouse to move onto the icon for giving focus to the aforementioned icon, or a selection of an icon by clicking on a mouse to start a related function.

Patent documents 1 and 2 have disclosed a technique for displaying a guidance to describe a function of specific icon selected from among all of displayed icons and carrying out the relevant function in the case of displaying a plurality of icons in a display part of a portable phone apparatus.

Although a screen of a portable phone displays various objects as described above, the meaning thereof are sometimes incomprehensible to the user. Particularly, icons displayed in a status display zone, which is called a status pane, of a portable phone are static objects only for displaying themselves.

Since the icons are objects illustrating the respective meanings and functions, some allow analogies of the related functions and meaning, others require references to the operator manual for understanding.

For example, an icon is displayed in the status pane indicating that there is an unreceived mail in a telecommunications center in the case of failing to receive the mail (due to being out of service, et cetera) at the time of receiving an incoming mail notice from the telecommunications center. This icon, however, is seldom displayed and therefore some user does not understand the reason for the aforementioned icon being displayed or the method for deleting it, resulting in being confused. It is therefore desirable to show the meaning of the icon and the method for handling it.

If there is a pointing function such as a mouse as in the case of a personal computer (PC), it is possible to move a mouse pointer not only to the normal zone (i.e., a standby zone) but also to the status pane for giving focus.

Even if there is no pointing function such a mouse, it is possible to give focus to an icon in a status pane as in the case of an icon in the normal zone. That is, a focus may merely be moved so as to circulate on all of icons located in the status pane and normal zone synchronously with pressing a specific key as disclosed by the above noted patent documents 1 and 2.

However, it is not desirable to have a capability of focusing in the same way as the frequently used icons located in the normal zone because the display of a meaning of an icon in the status pane or the startup of the related function is only infrequently used.

In other words, it is necessary to go through the infrequently used icons in the status pane before the focus reaches a frequently used icon if a specific icon is selected by the focus circulating among the icons synchronously with key operations, resulting in an increased number of key operations or required time and degrading operability.

[Patent document 1] Laid-Open Japanese Patent Application Publication No. 10-23117

[Patent document 2] Laid-Open Japanese Patent Application Publication No. 2000-349888

### SUMMARY OF THE INVENTION

A purpose of the present invention is to provide a technique for enabling an improvement of a focusing operation for objects such as plural kinds of icons of different attributes such as usage frequency.

Another purpose of the present invention is to provide a technique for enabling an improvement of operability relating to objects such as an infrequently used icon.

A first aspect of the present invention is to provide an information processing apparatus including a display unit; and a screen control unit for setting a plurality of different focus modes which selectively focus each of first objects displayed in a main display zone of the display unit and of second objects output to a status display zone of the display unit.

A second aspect of the present invention is to provide the information processing apparatus according to the first aspect, wherein the screen control unit displays a description of the second object, which is focused, in the focus mode relating to the second object displayed in the status display zone.

A third aspect of the present invention is to provide the information processing apparatus according to the first aspect, wherein the screen control unit sets or starts a function relating to the second object by an operation of selecting the aforementioned second object, which is focused, in the focus mode relating to the second object displayed in the status display zone.

A fourth aspect of the present invention is to provide the information processing apparatus according to the first aspect, further including an operation key used for inputting information, wherein the screen control unit changes the focus modes between the main display zone and the status display zone according to a length of time of pressing the operation key.

A fifth aspect of the present invention is to provide the information processing apparatus according to the first aspect, further including an operation key used for inputting information, wherein the screen control unit makes a focus moved among a plurality of the second objects responding to a pressing of the operation key in the focus mode for the second objects displayed in the status display zone.

A sixth aspect of the present invention is to provide a control method used for an information processing apparatus, including: a first step for outputting, to a display unit, a main display zone which displays first objects and a status display zone which displays second objects; and a second step for changing a focus mode to either of the first objects of the main display zone or the second objects of the status display zone.

A seventh aspect of the present invention is to provide the control method used for an information processing apparatus according to the sixth aspect, wherein a description relating to the second object, which is focused, is displayed in the focus mode for the second objects displayed in the status display zone.

An eighth aspect of the present invention is to provide the control method used for an information processing apparatus according to the sixth aspect, wherein a setup or start of a function relating to the second object is carried out by an operation of selecting the aforementioned second object, which is focused, in the focus mode for the second objects displayed in the status display zone.

A ninth aspect of the present invention is to provide the control method used for an information processing apparatus according to the sixth aspect, wherein the second step changes over the focus modes between the main display zone and the status display zone according to a length of time of pressing an operation key.

A tenth aspect of the present invention is to provide the control method used for an information processing apparatus according to the sixth aspect, wherein a focus is moved among a plurality of the second objects responding to a pressing of an operation key in the focus mode for the second objects displayed in the status display zone.

An eleventh aspect of the present invention is to provide a signal for carrying a control program used for an information processing apparatus including a display unit for displaying information, wherein the control program makes the information processing apparatus carry out a first step for outputting, to a display unit, a main display zone which displays first objects and a status display zone which displays second objects; and a second step for changing a focus mode to either of the first objects displayed in the main display zone or the second objects displayed in the status display zone.

A twelfth aspect of the present invention is to provide the signal for carrying a control program according to the eleventh aspect, wherein the control program makes the information processing apparatus carry out a display of a description relating to the second object, which is focused, in the focus mode for the second objects displayed in the status display zone.

A thirteenth aspect of the present invention is to provide the signal for carrying a control program according to the eleventh aspect, wherein the control program makes the information processing apparatus carry out a setup or a start of a function relating to the second object by an operation of selecting the aforementioned second object, which is focused, in the focus mode for the second objects displayed in the status display zone.

A fourteenth aspect of the present invention is to provide the signal for carrying a control program according to the eleventh aspect, wherein the control program makes the information processing apparatus change over the focus modes between the main display zone and the status display zone according to a length of time of pressing an operation key comprised by the information processing apparatus, in the second step.

A fifteenth aspect of the present invention is to provide the signal for carrying a control program according to the eleventh aspect, wherein the control program makes the information processing apparatus carry out an operation in which a focus is moved in among a plurality of the second objects responding to pressing of an operation key comprised by the information processing apparatus in the focus mode for the second objects displayed in the status display zone.

The above noted present invention provides a focus mode enabling a movement of a focus to objects such as an icon displayed in a status pane in addition to a focus mode for objects displayed in a normal display zone; and enables a display of a meaning of an object such as an icon displayed in the status pane, and a setup and/or processing relating to the aforementioned object.

That is, the present invention is comprised to implement a focus function of an object selection/movement type employing a cursor key for both the normal zone and status display zone specific to a portable phone in the case of an information processing apparatus, such as a portable phone, et cetera, which does not include a pointing cursor (e.g., a mouse cursor). A separate provision of a focus mode to each of the normal zone and status pane avoids a focusing of the status pane which is normally infrequently used, thereby improving operability.

Meanwhile, after a focus mode is once moved over to the status pane, the processing such as a display of a description relating to an object by focusing the aforementioned object such as a target icon, and moreover a setup or startup relating to the aforementioned object, become available. Therefore, operability of infrequently used objects on the status pane side also is improved.

### BRIEF DESCRIPTION OF THE DRAWINGS

FIG. 1 is a conceptual diagram exemplifying an operation of an information processing apparatus, a control method therefor and a control program according to an embodiment of the present invention;

FIG. 2 is a perspective view exemplifying an external view of an information processing apparatus according to an embodiment of the present invention;

FIG. 3 is a block diagram exemplifying a comprisal of an information processing apparatus according to an embodiment of the present invention;

FIG. 4 is a conceptual diagram exemplifying a structure of software installed in an information processing apparatus according to an embodiment of the present invention;

FIG. 5 is a conceptual diagram exemplifying a hierarchical relationship of software installed in an information processing apparatus according to an embodiment of the present invention;

FIG. 6 is a flow chart exemplifying an operation of a plurality of focus modes for an information processing apparatus according to an embodiment of the present invention;

FIG. 7 is a flow chart exemplifying a time event process for an information processing apparatus according to an embodiment of the present invention;

FIG. 8 is a flow chart exemplifying a stand-by display drawing process for an information processing apparatus according to an embodiment of the present invention;

FIG. 9 is a flow chart exemplifying a status pane display process for an information processing apparatus according to an embodiment of the present invention;

FIG. 10 is a flow chart exemplifying a focus-cursor value correction process for an information processing apparatus according to an embodiment of the present invention;

FIG. 11 is a conceptual diagram showing an arrangement state of a plurality of status icons for a status pane of an information processing apparatus according to an embodiment of the present invention; and

FIG. 12 is a description chart exemplifying a description balloon display process for an information processing apparatus according to an embodiment of the present invention.

### DESCRIPTION OF THE PREFERRED EMBODIMENTS

The following is a detailed description of the preferred embodiment of the present invention by referring to the accompanying drawings.

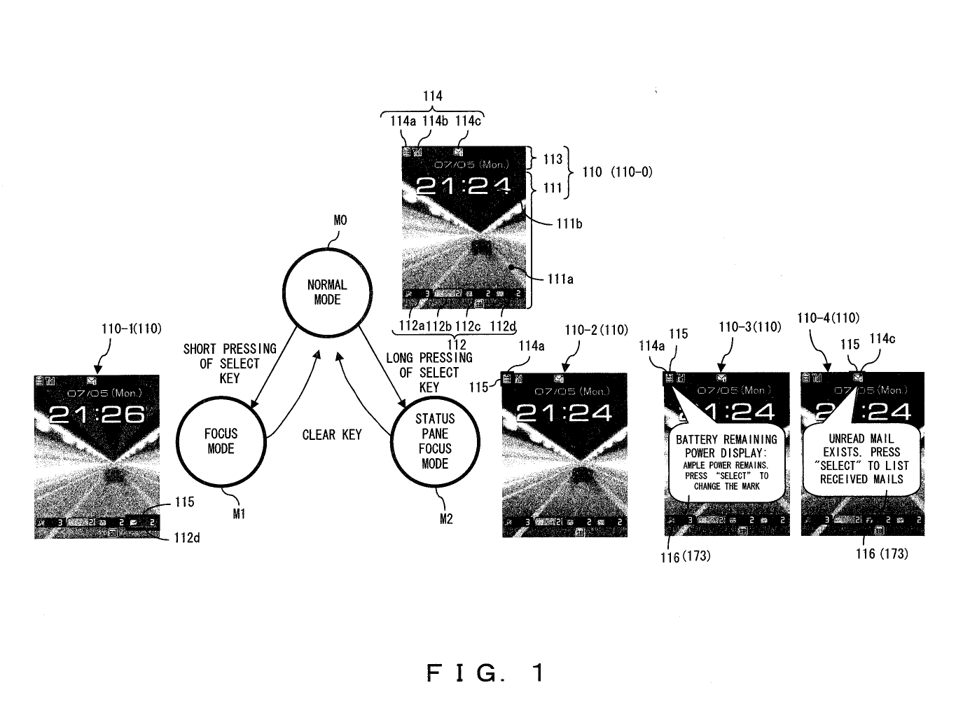

FIG. 1 is a conceptual diagram exemplifying an operation of an information processing apparatus, a control method therefor and a control program according to an embodiment of the present invention.

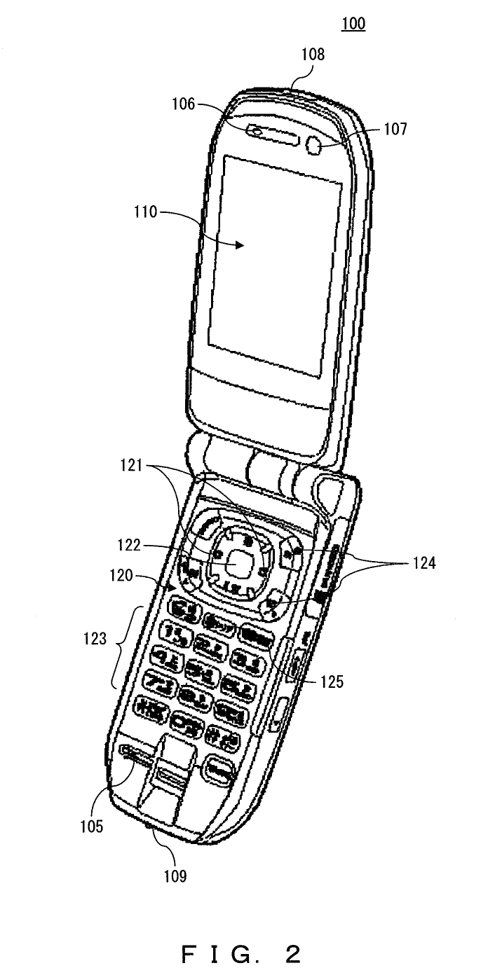

FIG. 2 is a perspective view exemplifying an external view of an information processing apparatus according to the present embodiment.

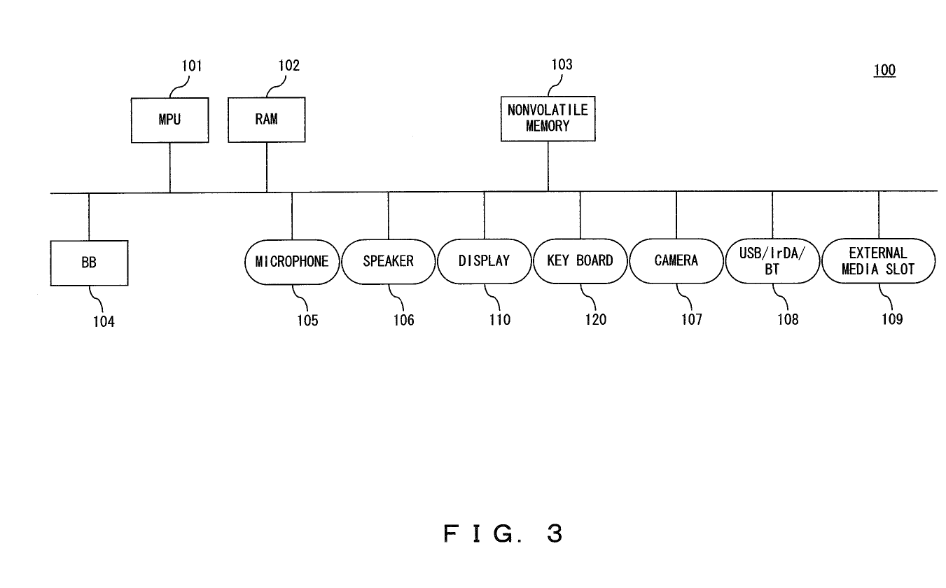

FIG. 3 is a block diagram exemplifying a comprisal of an information processing apparatus according to the present embodiment.

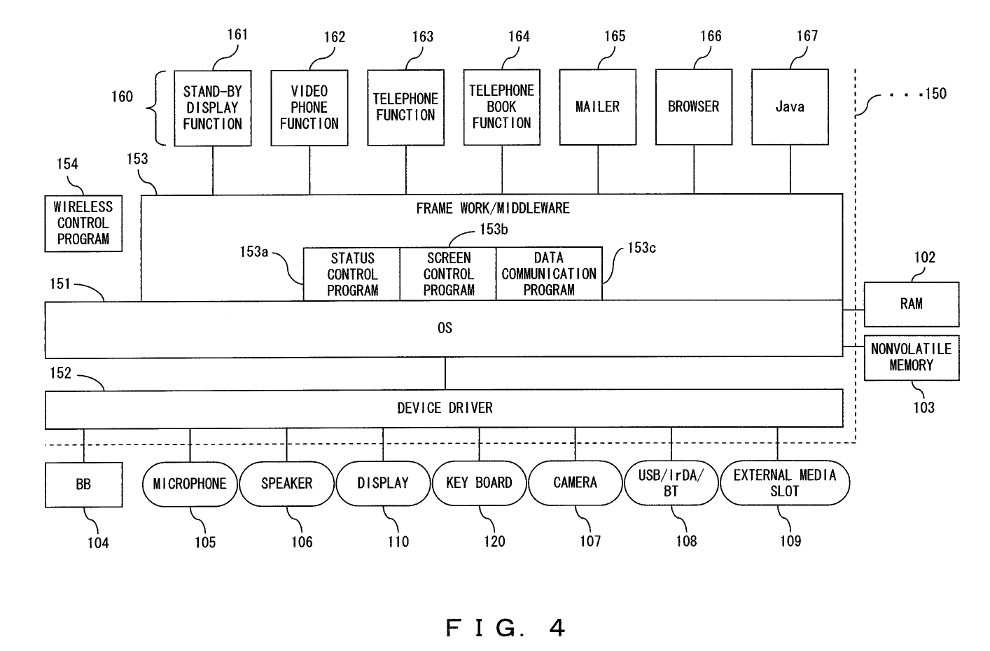

FIG. 4 is a conceptual diagram exemplifying a structure of software installed in an information processing apparatus according to the present embodiment.

The first description is of an example of hardware and software configurations of an information processing apparatus according to the present embodiment by referring to FIGS. 2, 3 and 4.

The description of the present embodiment exemplifies the case of applying to a portable phone 100 as an example of the information processing apparatus.

As exemplified by FIGS. 2 and 3, the portable phone 100 according to the present embodiment includes a microprocessor 101, a main storage 102, nonvolatile memory 103, a baseband process unit 104, a microphone 105, a speaker 106, a camera 107, an external input/output interface 108, an external media slot 109, a display 110 (i.e., a display unit) and a key board 120.

The microprocessor 101 controls the entirety of the portable phone 100 by executing later-described software 150 stored by the main storage 102.

The main storage 102 is constituted by a storage medium such as a RAM, and retains information such as the software 150, a later described status icon management table 170, et cetera.

The nonvolatile memory 103 is constituted by a rewritable nonvolatile storage medium and endurably stores the above described software 150 and status icon management table 170. The software 150 and data stored by the nonvolatile memory 103 are loaded to the main storage 102 and executed by the microprocessor 101. Or, the data stored by the nonvolatile memory 103 is accessed by the microprocessor 101.

The base band process unit 104 is hardware for implementing controls of a wireless telecommunication function and telecommunication protocol for the portable phone 100 for example.

The microphone 105 functions as telephone transmitter at a telephone call.

The speaker 106 functions as telephone receiver at a telephone call.

The camera 107 photographs an image of the user in the case of making the portable phone 100 function as video phone for example.

The external input/output interface 108 is disposed for an information and telecommunication with the outside by way of a communication interface such as a universal serial bus (USB), an infrared communication interface (IrDA), a short distance wireless communication interface (e.g., Bluetooth), et cetera.

The external media slot 109 is used for attaching an external storage media such as a semiconductor memory card.

The display 110 displays information by visualizing it.

The present embodiment is configured such that, as shown by the normal mode screen 110-0, et cetera, in FIG. 1, the screen of the display 110 comprises a main display zone 111 and a status pane 113 (i.e., a status display zone) which is positioned in the upper end thereof.

Icons 112 (i.e., first objects) which are furnished corresponding to a later described application program of the portable phone 100 for example are displayed in the main display zone 111. And, selection of one of the icons 112 starts a corresponding application program 160.

In the example shown by FIG. 1, the lower edge of the main display zone 111 displays a missed call number icon 112a, a message memo icon 112b, an answer-phone message icon 112c and an unread mail icon 112d as the icons 112.

The status pane 113 displays various status icons 114 (i.e., second objects) for indicating statuses of the portable phone 100.

In the example of the status pane 113 shown by FIG. 1, a battery condition icon 114a, a radio wave condition icon 114b and an unreceived mail icon 114c are displayed as the status icons 114.

The key board 120 comprises a cursor key 121, a select key 122, a number key 123, a soft key 124, a clear key 125, et cetera, as exemplified by FIG. 2.

The portable phone 100 according to the present embodiment is configured to place a plurality of cursor keys 121 so as to enclose the select key 122 from the up, down, left and right corresponding to moving-up, -down, -left and -right, respectively.

And the soft key 124 is placed at the position to enclose the cursor key 121.

The present embodiment is configured to place the keyboard 120 so as to be folded toward the display 110.

The speaker 106 as a telephone receiver and the camera 107 are placed on the display 110 side, while the microphone 105 as a telephone transmitter is placed on the key board 120 side.

The software 150 for controlling the portable phone 100 according to the present embodiment comprises as exemplified by FIG. 4.

The present embodiment is configured such that the nonvolatile memory 103 is installed by an operating system 151, a device driver 152, a middleware 153, a wireless control program 154 and an application program 160, as the software 150.

The operating system 151 controls the above described various kinds of hardware by way of the device driver 152.

The wireless control program 154 is software for controlling the baseband process unit 104 under management of the operating system 151.

The operating system 151 controls an execution of the application program 160 by way of the middleware 153.

The present embodiment is configured to equip a status control program 153a and a screen control program 153b in order to implement a later described individual focus control between the main display zone 111 and status pane 113.

And the middleware 153 is equipped with a data communication program 153c for the purpose of controlling a control of telecommunication protocol.

The present embodiment is configured to install a stand-by display function 161, a video phone function 162, a telephone function 163, a telephone book function 164, a mailer 165, a browser 166 and a Java execution environment 167 (Java is a trademark) as the application program 160.

The present embodiment is configured such that a later described changeover control of a focus between the main display zone 111 and status pane 113 is carried out by the screen control program 153b and status control program 153a, which are included in the above described middleware 153, and the stand-by display function 161.

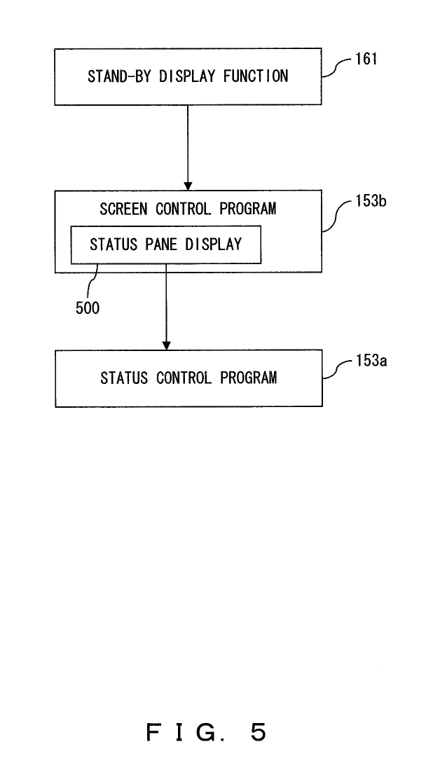

That is, the stand-by display function 161 (i.e., a screen control unit, and a control program) carries out a standby for an event in a later described stand-by display status (i.e., a normal mode screen 110-0), various processing at the time of obtaining an event and a stand-by display as exemplified by FIG. 5. Incidentally, an actual drawing of a screen is carried out by the screen control program 153b.

The screen control program 153b (i.e., a screen control unit and a control program) is a part for taking charge of actual screen drawing such as the status pane 113. There is drawing processing for each screen construction element.

The status control program 153a (i.e., a screen control unit and a control program) manages various states, including the states corresponding to the status icons 114 to be displayed in the status pane 113.

The following is a description of an example operation of the present embodiment.

As exemplified by FIG. 1, the portable phone 100 according to the present embodiment is configured such that a pressing of the select key 122 for a short time (i.e., a short press) causes a transition to a normal focus mode M1 (i.e., a focus mode screen 110-1), while a pressing of the select key 122 for a long time (i.e., a long press) causes a transition to a status pane focus mode M2, both from a normal mode M0 in which a stand-by display (i.e., a normal mode screen 110-0) is displayed.

A pressing of a clear key 125 or an elapsed time in a state of being left untouched causes a transition to the normal mode M0 from the focus mode M1 or status pane focus mode M2.

In the normal mode M0, displayed are: a stand-by display background 111a, a clock time 111b, icons 112 and status pane 113, with neither of the icons 112 in the main display zone 111 and the status icons 114 in the status pane 113 being focused. That is, a later described focus frame 115 does not exist.

In the focus mode M1, each of the icons 112 (that is, a missed call number icon 112a, a message memo icon 112b, an answer-phone message icon 112c or an unread mail icon 112d, in this case) within the focus mode screen 110-1 (i.e., the stand-by display) becomes a target of focusing. A discrimination of a focus among the plurality of icons 112 is performed by displaying the focus frame 115 enclosing a target icon 112.

A pressing of the cursor key 121 during the focus mode M1 moves the focus sequentially to an adjacent icon 112 on the left or right. A moving of the focus from the left end or right end moves the focus (i.e., a display of the focus frame 115) to the end icon 112 on the opposite side.

The present embodiment is configured such that the focus mode M1 is independent of the status pane focus mode M2, and therefore none of the status icons 114 within the status pane 113 is focused in the aforementioned focus mode M1.

In the example of the focus mode screen 110-1 shown by FIG. 1, the unread mail icon 112d is enclosed by the focus frame 115 to focus the aforementioned unread mail icon 112d. A pressing of the select key 122 starts up the mailer 165 to carry out a reception of an unread mail.

Meanwhile, in the case of a transition to the status pane focus mode M2, one of the status icons 114 displayed in the status pane 113 is focused and the focus frame 115 is displayed as exemplified by a status pane focus mode screen 110-2 shown in FIG. 1.

In the example of the status pane focus mode 110-2, the battery condition icon 114a with in the status pane 113 is enclosed by the focus frame 115, making it apparent that the aforementioned battery condition icon 114a is focused.

As described above, the status pane focus mode M2 is independent of the focus mode M1 and therefore none of the icons 112 on the main display zone 111 side is focused in the aforementioned status pane focus mode M2.

Furthermore, the present embodiment is configured such that, if a state in which a specific one of the status icons 114 is focused for a predetermined length of time continuously, a help text corresponding to the relevant status icon is automatically displayed as a balloon 116 in the status pane focus mode M2.

In the example shown by FIG. 1, a continuation of the state in which the battery condition icon 114a is displayed for a predetermined length of time in the status pane focus mode M2 has caused to display a balloon 116 for showing a help text, i.e., “Battery remaining power display: ample power remains. Press “Select” (i.e., the select key 122 in this case) to change the mark” as exemplified by the status pane focus mode screen 110-3.

This enables the user of the portable phone 100 to immediately understand the meaning of the battery condition icon 114a, a possible action in the current state, et cetera.

Also in the status pane focus mode M2, a twice-pressing of the cursor key 121 on the right side starting from the status pane focus mode screen 110-3 focuses the unreceived mail icon 114c by enclosing it by the focus frame 115, and then display the balloon 116 for including a help text, i.e., “Unread mail exists. Select (i.e., the select key 122 in this case) to show a list of received mails” if the aforementioned focused state continues for a predetermined length of time.

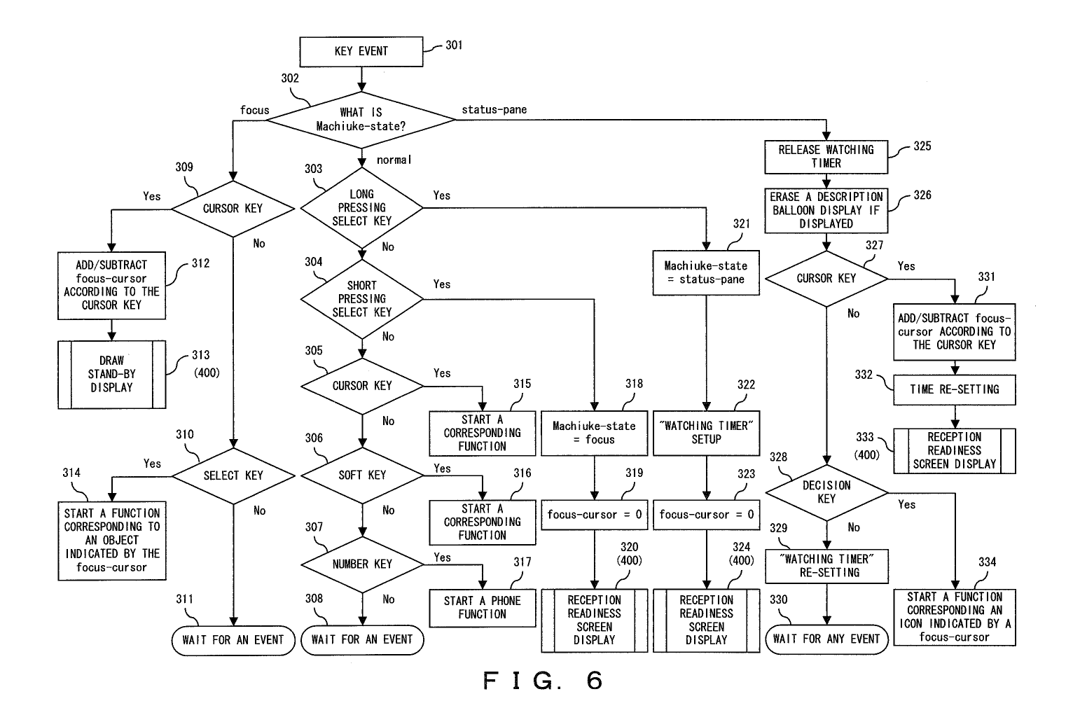

The following description is of an operation of the portable phone 100 according to the above described present embodiment by referring to the flow charts shown by FIGS. 6, 7, 8, 9, 10, 11 and 12.

Note that “Machiuke-state” is used as a variable for determining the normal mode M0, focus mode M1 or status pane focus mode M2 in the following description (N.B.: “Machiuke” is Japanese for “stand-by display”).

And that “focus-cursor” is used as a variable for managing a focus position of the icons 112 of the main display zone 111 and for the status icons 114 of the status pane 113.

The “Machiuke-state” indicates either of three states, i.e., “normal” corresponding to the normal mode M0, “focus” corresponding to the focus mode M1, and “status-pane” corresponding to the status pane focus mode M2.

First, in the state of the normal mode screen 110-0 shown by FIG. 1, a process wait for a key event to occur responding to an operation of the key board 120 (step 301).

The next process judges a state of the Machiuke-state when a key event is detected (step 302).

If the Machiuke-state is judged to be normal, that is, the normal mode M0, it first judges for a long pressing of the select key 122 (step 303).

If it is judged to be a long pressing, it first sets a status-pane for the Machiuke-state (step 321), and sets a watching timer for managing a display timing of the balloon 116 (step 322).

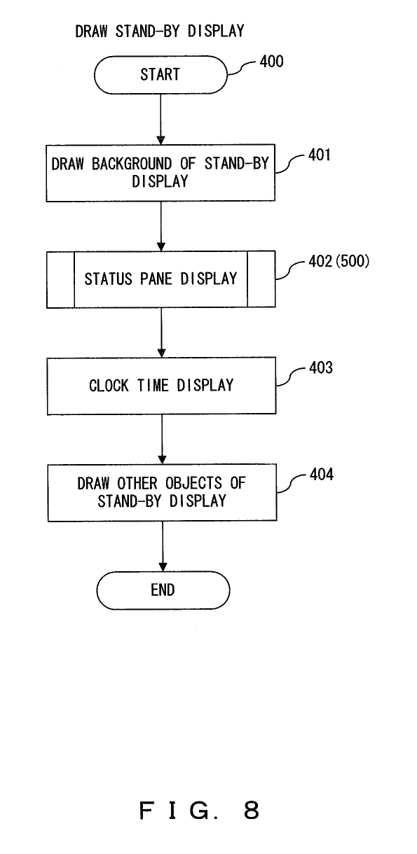

The next initializes the focus-cursor to “0” (step 323), followed by carrying out a stand-by display drawing process 400 exemplified by a later described FIG. 8 (step 324).

If the above described step 303 judges to be not a long pressing of the select key 122, the process judges whether or not a short pressing thereof (step 304).

If it is judged to be a short pressing of the select key 122, the process sets the Machiuke-state to “focus” (step 318), initializes the focus-cursor to “0” (step 319) and carries out the stand-by display drawing process 400 (step 320).

If it is judged to be not a short pressing in the step 304, the process judges whether or not an operation of the cursor key 121 (step 305) and, if it is judged to be a cursor key 121 being operated, then starts the corresponding function (step 315).

If it is judged to be not an operation of the cursor key 121 in the step 305, then judges whether or not an operation of the soft key 124 (step 306), while, if it is judged to be an operation thereof, then the process starts the corresponding function (step 316).

If it is judged to be not an operation of the soft key 124 in the step 306, then the process judges whether or not an operation of the number key 123 (step 307) and, if it is judged to be an operation thereof, then starts the telephone application programs such as the videophone function 162, telephone function 163, et cetera (step 317).

If it is judged to be not an operation of the number key 123 in the step 307, the process returns to the step 301, i.e., waiting for a key event (step 308).

If the Machiuke-state is judged to be “focus” in the above described step 302, that is, the focus mode M1, then the process first judges whether or not an operation of the cursor key 121 (step 309) and, if it is judged to be an operation thereof, the process adds or subtracts the focus-cursor according to the number of pressing of the cursor key 121 (step 312).

The present embodiment is configured to carry out an addition for the focus-cursor when pressing the cursor key 121 on the right, while a subtraction therefor when pressing the cursor key 121 on the left for example, by assuming an operation of the cursor key 121 in the left and right directions.

The above described processing is followed by carrying out the stand-by display drawing process 400 (step 313).

If it is judged to be not an operation of the cursor key 121 in the above described step 309, the process judges whether or not an operation of the select key 122 (step 310) and if the judgment is a pressing thereof, starts an application and a function which correspond to the icon 112 (i.e., an object) indicated by a value of the focus-cursor (step 314).

If it is judged to be not an operation of the select key 122 in the step 310, the process returns to the step 301, i.e., waiting for a key event (step 311).

If the Machiuke-state is judged to be “status pane” in the above described step 302, that is, the status pane focus mode M2, the process first releases the timer for controlling a display timing of the balloon 116 (step 325), followed by erasing a display of an existing balloon 116 if there is such a display (step 326).

Then followed by judging whether or not an operation of the cursor key 121 (step 327) and, if it is judged to be an operation thereof, controlling a value of the focus-cursor corresponding to the operation of the cursor key 121 (step 331).

Then, the process carries out a watching timer re-setting (step 332), followed by carrying out the stand-by display drawing process 400 (step 333).

If it is judged to be not an operation of the cursor key 121 in the above described step 327, the process judges whether or not an operation of the select key 122 (step 328) and, if it is judged to be an operation thereof, starts a function corresponding to a status icon 114 corresponding to the value of the focus-cursor in the status pane 113 (step 334).

If it is judged to be not an operation of the select key 122 in the step 328, the process carries out a watching timer re-setting (step 329) and return to the step 301, i.e., waiting for a key event (step 330).

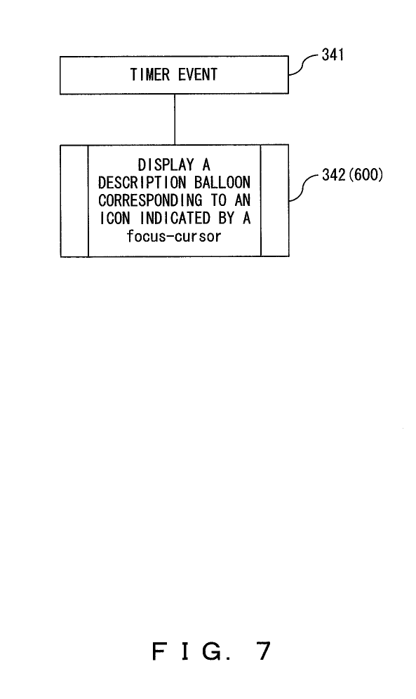

When elapsing the setup time of the timer set up as described above, a watching timer event occurs as exemplified by the flow chart shown by FIG. 7 (step 341), a later described description balloon display process 600 is carried out in order to display a balloon 116 corresponding to a status icon 114 corresponding to a position (i.e., a later described icon ID 171 in the case of the present embodiment) responding to the timer event (step 342).

FIG. 8 is a flow chart exemplifying the above described stand-by display drawing process 400. The stand-by display drawing process 400 displays the stand-by display background 111a in the main display zone 111 (step 401), carries out a status pane display process 500 (step 402), displays a clock time 111b (step 403) and displays the icons 112 which are other objects of stand-by display (step 404).

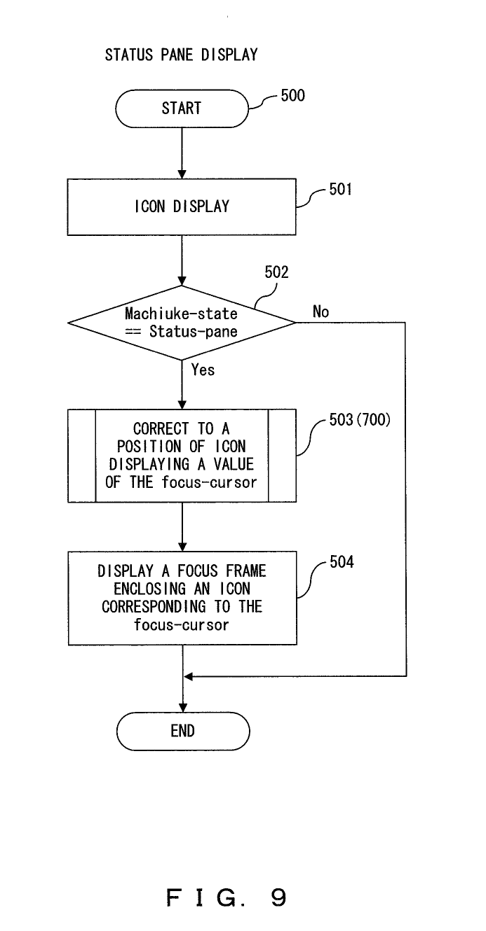

FIG. 9 is a flow chart exemplifying a status pane display process 500.

The status pane display process 500 displays the status icons 114 within the status pane 113 (step 501).

Then, it judges whether or not the Machiuke-state is “status-pane”, that is, the status pane focus mode M2 (step 502) and, if it is not the status pane focus mode M2, then nothing is performed.

Contrarily, if it is judged to be the status pane focus mode M2 in the step 502, the process carries out a focus-cursor value correction process 700 (step 503) and displays the focus frame 115 enclosing the corresponding status icon 114 (step 504).

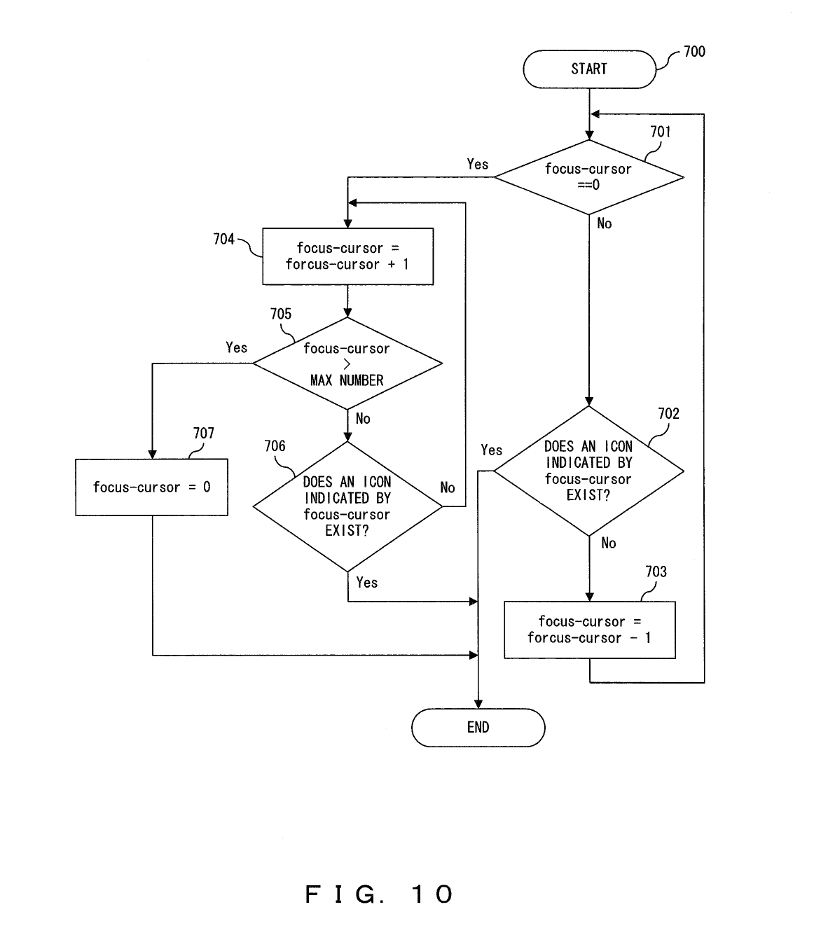

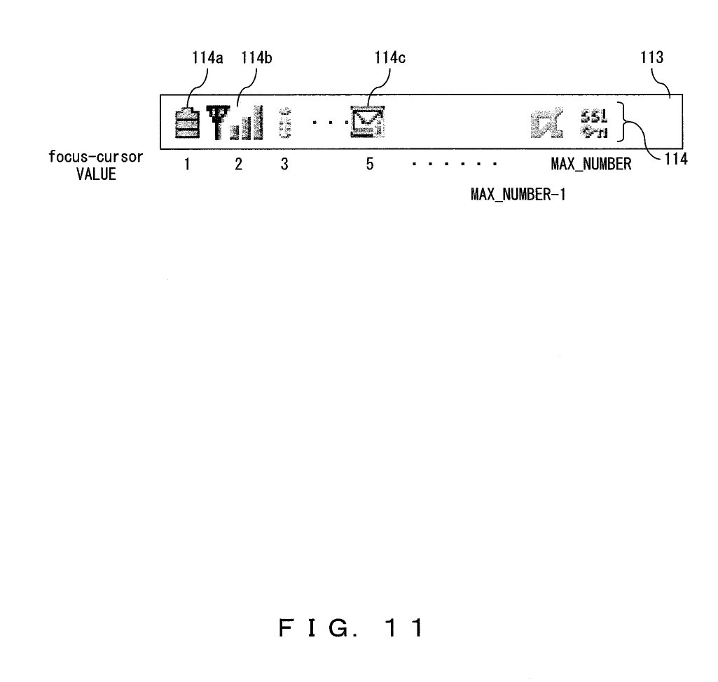

FIG. 10 is a flow chart exemplifying a focus-cursor value correction process 700. FIG. 11 is a conceptual diagram showing an arrangement state of the plurality of status icons for the status pane 113. As shown by FIG. 11, a MAX_NUMBER in the following description means the maximum number of the status icons 114 being displayed in the status pane 113.

The focus-cursor value correction process 700 carries out the processes, as follows, for the purpose of correcting a value of the focus-cursor to the position of status icons 114.

That is, if the focus-cursor is “0”, the process re-sets to the utmost left icon among the existing status icons 114. If there is no status icon 114, the focus-cursor is set to “0”. If a status icons 114 previously set disappears, the process re-sets to a status icon 114 on the most adjacent left thereof.

The focus-cursor value correction process 700 judges whether or not the focus-cursor is “0” (step 701) and, if the focus-cursor is judged to be not “0”, the process judges whether or not a status icon 114 exists at the position indicated by the value of the focus-cursor (step 702), followed by subtracting “1” from the value thereof, if the aforementioned status icon 114 does not exist (step 703), and returning to the step 701.

If the focus-cursor is judged to be “0” in the step 701, the process adds “1” to the focus-cursor (step 704).

Then it judges whether or not the focus-cursor has exceeded the MAX_NUMBER (i.e., it has exceeded the utmost right of the array of the status icons 114 (step 705).

And, if the focus-cursor is judged to have not exceeded the MAX_NUMBER, the process judges whether or not a status icon 114 exists at the position corresponding to the current focus-cursor (step 706) and, if it does not exist, returns to the above described step 704.

If a status icon 114 is judged to exist at the position corresponding the focus-cursor in the step 706, the focus-cursor value correction process 700 ends.

If the focus-cursor is judged to have exceeded the MAX_NUMBER in the above described step 705, the focus-cursor is set to “0” (step 707), followed by ending the focus-cursor value correction process 700.

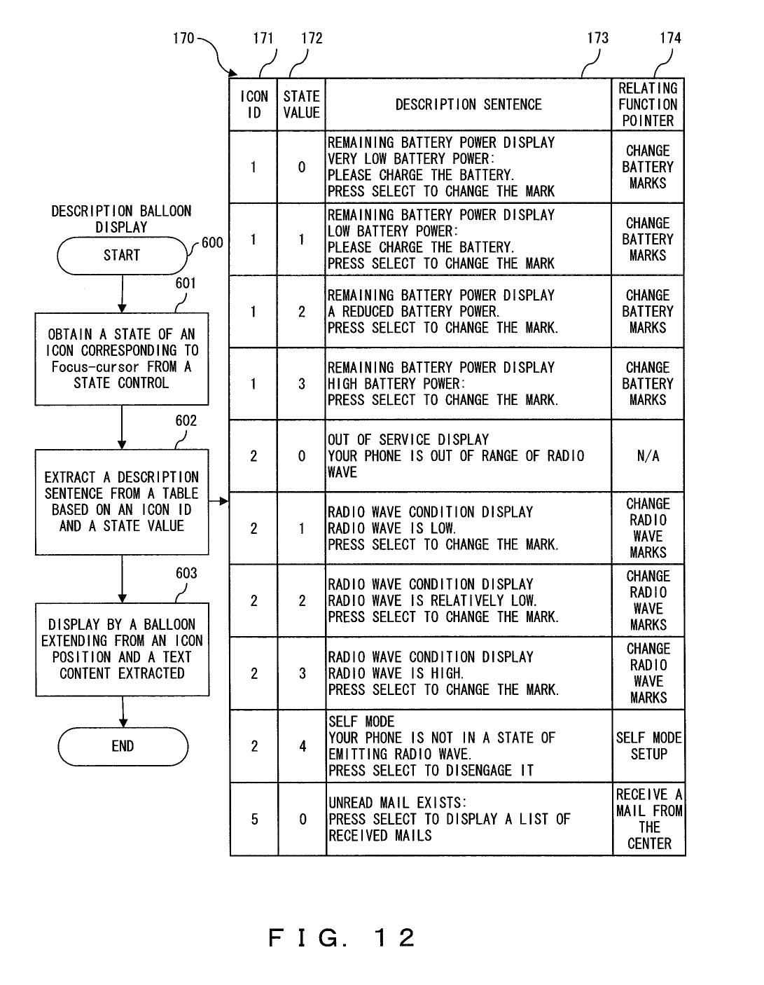

FIG. 12 is a description chart exemplifying a description balloon display process 600.

The description balloon display process 600 is carried out at the time of detecting a watching timer event in the above described step 342 shown by FIG. 7.

A status icon management table 170 is used for the description balloon display process 600. The status icon management table 170 stores information, i.e., state values 172, description sentences 173, and relating function pointers 174, with each thereof related to an icon ID 171.

This makes it possible to display a description sentence 173 corresponding to each of the different states in a single status icon 114 and also execute a program pointed by the relating function pointer 174.

The description balloon display process 600 obtains a state of the status icon 114 corresponding to the value of the focus-curser from the status control program 153a of the middleware 153 (step 601), and extracts a description sentence 173 from the status icon management table 170 based on the icon ID 171 and state value 172 (step 602).

And the process displays, in the balloon 116 extending from the status icon 114 which is focused and enclosed by the focus frame 115, the description sentence 173 extracted in the step 602 a status pane focus mode screen 110-3 and status pane focus mode screen 110-4 which are shown by FIG. 1.

As described thus far, the present embodiment is configured such that the icons 112 displayed in the main display zone 111, and the status icons 114 displayed in the status pane 113, of the display 110 are equipped with the independent focus mode M1 and status pane focus mode M2 in the portable phone 100. And it is configured to carry out a focusing operation, by using the focus frame 115, for the frequently used icons 112 independently from each of the status icons 114 which are relatively infrequently used.

This greatly improves operability for the side of the frequently used icons 112 as compared to a case of a uniform focusing operation for the icons 112 and status icons 114 by a common focus mode for instance.

That is, it improves operability of focus operations for the objects such as pluralities of the icons 112 and status icons 114 which have different attributes such as usage frequencies.

It is also possible to make the balloon 116 automatically display a description sentence 173 relating to the status icon 114 which is being focused by a watching timer setup for instance in the status pane focus mode M2, because focusing a relatively infrequently used status icon 114 is enabled.

This enables the user of the portable phone 100 to easily comprehend the meaning of a status icon 114 and the executable function just by focusing on the aforementioned status icon 114 which is incomprehensible to him and infrequently used.

This also enables an execution of the function corresponding to a status icon 114 by making the aforementioned status icon focused followed by pressing the select key 122.

That is, this enables the user of the portable phone 100 to firmly understand, and take an appropriate action to, a relatively infrequently used status icons 114 displayed in the status pane 113.

Therefore this enables an improvement of operability relating to the objects such as the infrequently used status icons 114, et cetera.

It is apparent that the present invention can be variously changed within the scope thereof in lieu of being limited by the configuration exemplified by the above described embodiment.

The present invention enables an improvement of operability of a focusing operation for objects such as a plurality of icons with different attributes such as usage frequencies.

It also enables an improvement of operability for objects such as infrequently used icons, et cetera.

What is claimed is:

1. An information processing apparatus, including:
a display unit; and
a screen control unit for setting a plurality of different focus modes which selectively focus each of first objects displayed in a main display zone of the display unit and of second objects output to a status display zone of the display unit.

2. The information processing apparatus according to claim 1, wherein
said screen control unit displays a description of said second object, which is focused, in said focus mode relating to the second object displayed in said status display zone.

3. The information processing apparatus according to claim 1, wherein
said screen control unit sets or starts a function relating to said second object by an operation of selecting the aforementioned second object, which is focused, in said focus mode relating to the second object displayed in said status display zone.

4. The information processing apparatus according to claim 1, further comprising
an operation key used for inputting information, wherein
said screen control unit changes said focus modes between said main display zone and said status display zone according to a length of time of pressing the operation key.

5. The information processing apparatus according to claim 1, further comprising
an operation key used for inputting information, wherein
said screen control unit makes a focus moved among a plurality of said second objects responding to a pressing of the operation key in said focus mode for the second objects displayed in said status display zone.

6. A control method used for an information processing apparatus, including:
a first step for outputting, to a display unit, a main display zone which displays first objects and a status display zone which displays second objects; and
a second step for changing a focus mode to either of the first objects of the main display zone or the second objects of the status display zone.

7. The control method used for an information processing apparatus according to claim 6, wherein
a description relating to said second object, which is focused, is displayed in said focus mode for the second objects displayed in said status display zone.

8. The control method used for an information processing apparatus according to claim 6, wherein
a setup or start of a function relating to said second object is carried out by an operation of selecting the aforementioned second object, which is focused, in said focus mode for the second objects displayed in said status display zone.

9. The control method used for an information processing apparatus according to claim 6, wherein
said second step changes over said focus modes between said main display zone and said status display zone according to a length of time of pressing an operation key.

10. The control method used for an information processing apparatus according to claim 6, wherein
a focus is moved among a plurality of said second objects responding to a pressing of an operation key in said focus mode for the second objects displayed in said status display zone.

11. A signal for carrying a control program used for an information processing apparatus including a display unit for displaying information, wherein
the control program makes the information processing apparatus carry out
a first step for outputting, to a display unit, a main display zone which displays first objects and a status display zone which displays second objects; and
a second step for changing a focus mode to either of the first objects displayed in the main display zone or the second objects displayed in the status display zone.

12. The signal for carrying a control program according to claim 11, wherein
the control program makes the information processing apparatus carry out
a display of a description relating to said second object, which is focused, in said focus mode for the second objects displayed in said status display zone.

13. The signal for carrying a control program according to claim 11, wherein
the control program makes the information processing apparatus carry out
a setup or start of a function relating to said second object by an operation of selecting the aforementioned second object, which is focused, in said focus mode for the second objects displayed in said status display zone.

14. The signal for carrying a control program according to claim 11, wherein
the control program makes the information processing apparatus change over said focus modes between said main display zone and said status display zone according to a length of time of pressing an operation key comprised by the information processing apparatus, in said second step.

15. The signal for carrying a control program according to claim 11, wherein
the control program makes the information processing apparatus carry out an operation in which a focus is moved in among a plurality of said second objects responding to pressing of an operation key comprised by the information processing apparatus in said focus mode for the second objects displayed in said status display zone.
